(19) United States
(12) Patent Application Publication
(10) Pub. No.: US 2003/0065830 A1
(43) Pub. Date: Apr. 3, 2003

(54) Parameters for an adaptive modem

(76) Inventors: Chien-Cheng Tung, Fremont, CA (US); Thomas Paul, Santa Clara, CA (US); Zhengjin Shu, Fremont, CA (US); Gary A. Anwyl, Palo Alto, CA (US); Derek Obata, Fremont, CA (US)

Correspondence Address: Omkar K. Suryadevara, SKJERVEN MORRIL MacPHERSON LLP, Suite 700, 25 Metro Drive, San Jose, CA, 95110-1349, US

(21) Appl. No.: 10/066,046

(22) Filed: Jan. 31, 2002

Related U.S. Application Data
(60) Provisional application No. 60/326,136, filed on Sep. 28, 2001.
(60) Provisional application No. 60/326,094, filed on Sep. 28, 2001.
(60) Provisional application No. 60/326,090, filed on Sep. 28, 2001.

(51) Int. Cl. G06F 3/00

(52) U.S. Cl. 710/8

(57) ABSTRACT

A computer automatically measures one or more parameters (also called “observable parameters”; examples include number being dialed and line probing result), and the computer uses the measurements to identify a set of values of parameters (also called “controllable parameters”; examples include equalizer coefficients, echo canceller coefficients, and disabling of V.8bis/Kflex) from non-volatile memory, for use in a current connection. The values of controllable parameters in each set may have been saved in non-volatile memory while operating the modem in a previous connection, or may be default values set by the factory, for example. Use of a previously saved set of controllable parameter values to operate a modem during a current connection, saves time otherwise required to independently generate a set of values each time the modem is operated and increases modem performance.

### CROSS-REFERENCE TO RELATED APPLICATIONS

This application claims priority from and incorporates by reference herein in their entirety, the following commonly owned co-pending provisional U.S. Patent Applications:

Serial No. 60/326,136, entitled “Reuse of Learned Parameters in a Modem” filed by Chien-Cheng Tung, Thomas Paul, Gary Anwyl, Derek Obata and Zhengjin Shu on Sep. 28, 2001;

Serial No. 60/326,094, entitled “Tuning and Reporting on Parameters and Algorithms in a Modem”, filed by Chien-Cheng Tung, Thomas Paul, Gary Anwyl and Derek Obata on Sep. 28, 2001; and

Serial No. 60/326,090 entitled “Adaptive Modem”, filed by Zhengjin Shu, Chien-Cheng Tung, Thomas Paul, Gary Anwyl and Derek Obata on Sep. 28, 2001.

This application is also related to and incorporates by reference herein in their entirety, the following commonly owned co-pending nonprovisional U.S. patent applications:

Attorney Docket No. M-12492 US, entitled “Channel Equalization” filed by Zhengjin Shu et al., filed concurrently herewith.

Ser. No. 09/967,758, entitled “Interrupt Counter” filed by Long Wang on Sep. 28, 2001; and

Ser. No. 09/967,750, entitled “Adaptive Buffer for Reducing Net Interface Latency” filed by Long Wang on Sep. 28, 2001.

### CROSS-REFERENCE TO ATTACHED APPENDIX

Appendix A contains the following files in one CD-ROM (of which two identical copies are attached hereto), and is a part of the present disclosure and is incorporated by reference herein in its entirety: Volume in drive D is 020124_{—}1717

Volume Serial Number is F3C2-3D4D
Directory of D:/
01/24/02 05:l7p<DIR>
01/24/02 05:l7p<DIR>
01/23/02 10:09a 28,937 APMMAN˜1.C
01/22/02 05:05p 48,290 SHU_R1˜1.C

4 File(s) 77,227 bytes

Total Files Listed:

4 File(s) 77,227 bytes

0 bytes free

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Modems are well known in the art for coupling computers to one another, and often incorporate other functions, such as a fax function, a speakerphone function, and answering machine function. Such modems can be implemented completely in hardware, or alternatively in a combination of hardware and software. Depending on the proportion of software and hardware, such modems may use a host processor, such as a central processing unit, to perform the traditional functions of a controller, in which case the modems are also called controller-less modems. Other modems may perform the traditional signal processing functions of the modem in a host processor; in which case, the modems may be called host signal processor (HSP) modems. Moreover, depending on the application, the modems may be either external or internal to a computer, and the modems are respectively coupled to a serial port, or a bus of the computer.

For more information on HSP modems, see U.S. Pat. Nos. 5,787,305, 5,940,459, 5,765,021, 5,982,814, 5,721,830, and 6,112,266, all of which are incorporated by reference herein in their entirety.

### SUMMARY

In accordance with this invention, a modem automatically measures one or more parameters (also called “observable parameters”; examples include number being dialed and line probing result), and the modem uses the measurements to identify a set of values of parameters (also called “controllable parameters”; examples include equalizer coefficients, echo canceller coefficients, and disabling of V.8bis/Kflex) from non-volatile memory, for use in a current connection. The values of controllable parameters in each set (of one or more sets) may have been saved in non-volatile memory while operating the modem in a previous connection, or may be default values set by the factory, for example. Loading and using a previously saved set of controllable parameter values to operate a modem during a current connection, saves time otherwise required to independently generate a set of values each time the modem is operated. Therefore, a modem in accordance with this invention is faster to operate than modems of the prior art. Use of a previously saved set of controllable parameter values to operate a modem during a current connection, also improves modem performance (e.g. improves connection stability and/or throughput).

The set of values of controllable parameters that are initially loaded may be adjusted during operation of the modem, and therefore, in one embodiment of the modem, a current set of values of controllable parameters is saved for future use. Depending on the implementation, during such saving a new set of values may overwrite previously saved set of values, or alternatively may be saved separately. The newly saved set of values of controllable parameters may correspond to either the same measurements as a previously-saved set of values, or may correspond to a different set of measurements. Use of multiple sets of values, with each set of values corresponding to a different set of measurements provides distinct identities to the modem depending on the circumstances under which the modem is operated. For example, the same modem may behave differently with a home telephone line and an office telephone that are respectively connected to different local loops of the telephone company, and therefore have different set of measurements.

To guide the above-described act of adjustment of the values of controllable parameters during operation, the modem may identify the difference between a measurement of an observable parameter and a corresponding reference for the observable parameter, and use the difference to determine the appropriate adjustment to be made.

### BRIEF DESCRIPTION OF THE DRAWINGS

FIG. 1 illustrates, in a block diagram, a tuner that sets a number of controllable parameters of a modem, based on measurements of a number of observable parameters.

FIG. 2 illustrates, in a high-level flow chart, a method supported by the tuner of FIG. 1.

FIG. 3 illustrates, in a low level flow chart, one implementation of act 209 of FIG. 2.

FIG. 4 illustrates, in an intermediate level flow chart, one embodiment of the method of FIG. 2 that adjusts values of controllable parameters based on performance.

FIG. 5 illustrates, in a low level flow chart, acts performed by the tuner in one specific implementation that informs the user if the problem with performance is not automatically fixable.

FIG. 6 illustrates, in a high-level block diagram, a tuner that displays a message through a user interface on a display device.

### DETAILED DESCRIPTION

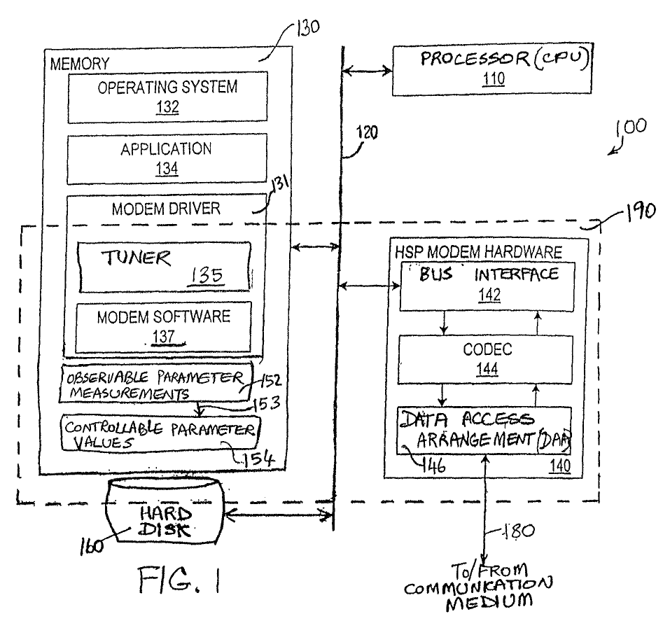

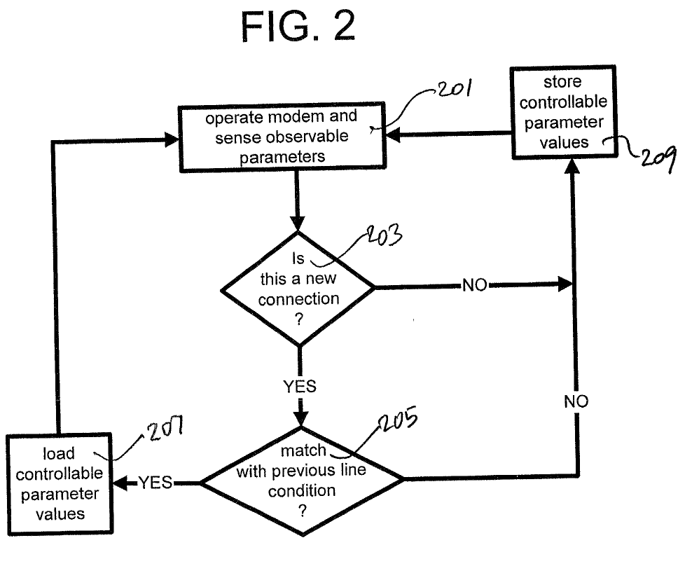

A computer 100 (FIG. 1) in accordance with this invention when programmed with software (also called “tuner”) 135 operates a modem 190, as illustrated by act 201 (FIG. 2). In act 201, computer 100 also automatically senses one or more parameters (also called “observable parameters”) of modem 190 (FIG. 1) as illustrated by act 201 (FIG. 2). The measurements made in act 201 are used to identify and load values of parameters (also called “controllable parameters”) that govern the behavior of modem 190, as illustrated by acts 205 and 207.

Observable parameters are any parameters (related to modem 190 and/or to computer 100) that are normally sensed during normal operation (of the modem or computer). Additionally, any parameters that may be needed to measure performance of modem 190 may also be measured in act 201. Examples of observable parameters that may be sensed include, for example, the telephone number being dialed, line probing result, receive power, error rate, data rate, and in case of a HSP modem, the number of missed interrupts, CPU utilization and memory utilization. The specific set of observable parameters that are to be sensed, may be predetermined, e.g., hard-coded into software resident in hard disk 160 (FIG. 1) and executed by a central processing unit (CPU) to implement a tuner 135 illustrated by performance of the method in FIG. 2.

Controllable parameters are any parameters (related to modem 190 and/or to computer 100) that affect normal operation (of the modem and/or computer), and in some cases the same parameter may be both an observable parameter and a controllable parameter. Examples of controllable parameters that may be set include, for example, the transmit power, whether or not V.8bis and Kflex are preformed, echo canceller coefficients and equalizer coefficients.

When programmed with tuner 135, computer 100 determines if a new connection is being formed (see act 203 in FIG. 2). Initially this is true, so computer 100 uses measurements 152 (FIG. 1) obtained from act 201 to determine if they match a set of previous measurements that are held in non-volatile memory (such as hard disk 160). Depending on the embodiment and/or the measurement, the matching may be exact (e.g. the telephone number being dialed be identical) or the matching may be approximate (e.g. the CPU utilization and/or memory utilization may be within a predetermined range, and the range may be a percentage, e.g. 10% a).

If there is a match, computer 100 (FIG. 1) loads from non-volatile memory into memory 130 an associated set 154 (FIG. 1) of values of controllable parameters. Values of controllable parameters in set 154 may be obtained during operation of modem 190 in a previous connection (assuming the modem 190 has been operated at least once previously), as illustrated by act 209 in FIG. 2. In act 209, computer 100 saves the current set of values of controllable parameters, and may optionally save the current measurements of observable parameters, and an association therebetween, for use in operating the modem in a future connection. Alternatively, such values may be stored in non-volatile memory at a factory.

Regardless of how they originate, the values of controllable parameters in set 154 that are held in non-volatile memory are used in accordance with the invention to operate modem 190 during a current connection. Previously-saved values in set 154 are used only if there was a match between the current line conditions and previous line conditions (thereby to indicate that the previously-saved controllable parameter values are applicable to the current connection). The two sets 154 and 152 (i.e. controllable parameter set 154 that is loaded when observable parameter set 152 is matched) may be associated with one another in any manner, e.g. by a pointer 153, or even simply by physical proximity to one another in non-volatile memory.

The values of controllable parameters in set 154 that are loaded (see act 207 in FIG. 2) from non-volatile memory may have been stored therein during previous operation of modem 190, e.g. when the previous connection was no longer a new connection. A connection may be determined in act 203 to be not a new connection during normal operation, e.g. after any phase and also in case of a retrain or reconnect. Depending on the embodiment, computer 100 may go from act 201 to act 203 only once during each connection, e.g. initially on power-up of modem 190. In an alternative embodiment, computer 100 goes from act 201 to act 203 a number of times during each connection, and such transition may be periodic by design (e.g. every 1 minute), or triggered by connection-related events such as a retrain due to excessive error in transmission of user data.

In one embodiment, factory-stored default values that are used initially in setting up a connection, are changed to new values, for example, due to adjustment of the values for a local loop that is currently in use (e.g. different local loops may be available at home and at the office). Such changes are stored in the act of 209 as a result of, for instance, periodic transitions from 201 to 203 as mentioned above.

In the above-described act 205, one or more measurements may be checked to see if the measurements fall within a predetermined set of limits around previous measurements 152, and if so the values in the associated set 154 are loaded. Therefore, in act 205, instead of checking a single measurement, a set of measurements may be checked to see if they fit a pattern, depending on the embodiment.

In one embodiment, tuner 135 and modem software 137 use a number of storage elements 152-154 in memory 130 e.g. observable parameter measurements 152, controllable parameter values 154 and an association 153. Specifically, tuner 135 loads appropriate values of controllable parameters into storage elements 154 in memory 130, and the values are used by modem software 137 to change its behavior during operation (as illustrated by act 201 in FIG. 2). Moreover, depending on the embodiment, a number of portions of the software for tuner 135 may communicate with or be interspersed across various portions of modem software 137.

Tuner 135 of one embodiment is implemented as a set of computer instructions that are included in modem driver 131, as illustrated in FIG. 1. Depending on the embodiment, modem driver 131 may or may not include computer instructions to implement a controller and/or a modem in software, such as modem software 137. When present, modem software 137 is responsive to tuner 135. However, such a tuner can also be implemented in hardware or in a combination of hardware and software, in alternative embodiments. Such tuner-related hardware may be included in, for example, HSP modem hardware 140 (FIG. 1). HSP modem hardware 140 includes a bus interface 142 that provides an interface to a bus 120, a codec 144 that performs analog to digital and digital to analog conversions, and a data access arrangement 146 that connects to and provides an interface with the communication medium 180.

In an exemplary embodiment, computer system 100 is an IBM PC compatible system, and bus 120 is a local bus, such as a PCI, VESA, or ISA bus. CPU 110 is a processor that implements the x86 instruction set, such as the Intel Pentium processor. Other types of processors, buses and instructions sets may be used in such a computer 100. Moreover, in one embodiment, operating system 132 (FIG. 1) resident in memory 130 is a Microsoft Windows operating system, such as Windows 2000, and supports other applications, such as application 134 which may be, for example, Microsoft Word.

HSP modem hardware 140 is a hardware portion of an HSP modem 190 shown by the dashed line, which includes computer instructions, such as modem software 137, tuner 135, as well as data 152-154 that are held in memory 130 for use by the CPU 110. Note that although a single bus 120 is illustrated in FIG. 1, any number of buses may be present in computer 100, between HSP modem hardware 140 and processor 110.

Memory 130 is commonly implemented as a hierarchical memory system that may include one or more levels of caches, and main memory. Computer system 100 includes a hard disk 160, which may be replaced by other types of nonvolatile memory depending on the embodiment. Also depending on the embodiment some type of nonvolatile memory may or may not form a portion of a modem. For example, in FIG. 1, a portion of hard disk 160 is included in modem 190 for storage of the values of one or more parameters, for use by modem 190 in forming a connection in future.

Modem software 137 (FIG. 1) implements a number of modem functions, such as modulation to convert data into samples representing an analog signal for transmission by HSP modem hardware 140 to a communication medium 180, such as a telephone line, and demodulation of a signal received from the communication medium, based on a series of samples provided by HSP modem hardware 140. Modem software 137 may implement one or more communication protocols, such as V.34, and V.90. One specific embodiment of modem software 137 is described in U.S. Pat. No. 5,721,830 which is incorporated by reference herein in its entirety.

In one embodiment, computer 100 performs act 209 with only one set of storage elements for the controllable parameter values, so that previously-saved values are repeatedly over-written. In alternative embodiments, computer 100 performs act 209 with different sets of storage elements, so that previously-saved values are only over-written under certain circumstances.

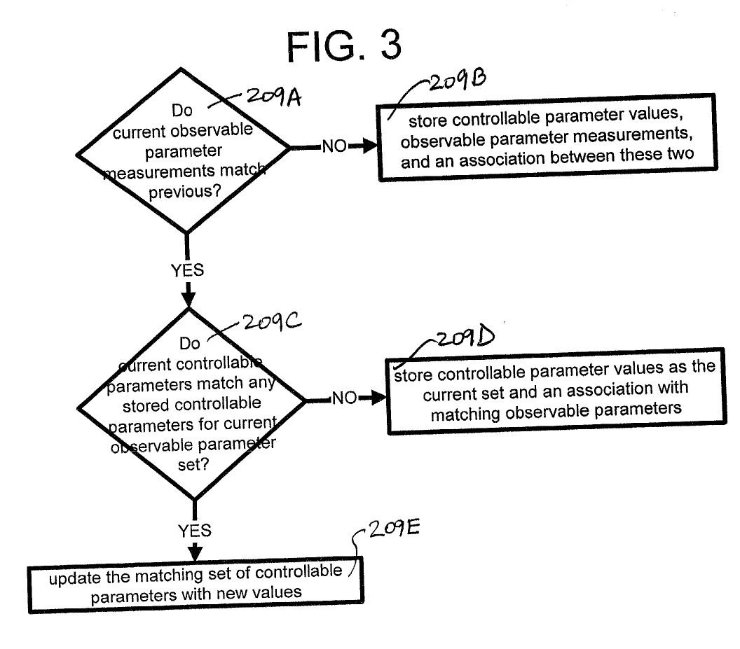

In one such alternative embodiment, computer 100 implements act 209 as illustrated in FIG. 3, e.g. checks in act 209A whether the current observable parameters measurements match the previously-saved measurements 152 (FIG. 1). If there is no match, computer 100 saves the current values of controllable parameters separate from the previously saved values of controllable parameters, as illustrated by act 209B. In act 209B, computer 100 also saves the current measurements of observable parameters (or alternatively ranges based on current measurements), and an association. The saved values of controllable parameters may be used in a future connection, if the observable parameters measurements of the future connection match (i.e. are identical to or fall within ranges defined by) the corresponding observable parameters measurements associated with the saved values of controllable parameters.

If there is a match in act 209A, computer 100 optionally checks in act 209C if the current values of controllable parameters match the previously stored values of controllable parameters. If there is a match in act 209C, computer 100 goes to act 209E to simply update the controllable parameter set with the current values (i.e. the current values over-write the previous values). Therefore, in act 209E, a new set of controllable parameter values are not stored, and instead the existing sets and the related associations remain unchanged. If there is no match in act 209C, computer 100 goes to act 209D to save the current values of controllable parameters in a new set that is also associated with the set of current measurements of observable parameters.

If there is a match in act 209A, computer 100 need not perform act 209C (described above), and instead may directly go to act 209E in another alternative embodiment. In such an embodiment, computer 100 maintains only one set of controllable parameter values for each set of measurements of observable parameters, whereas when act 209D is performed, computer 100 maintains multiple sets of controllable parameter values for each set of measurements of observable parameters. In one such implementation, when act 209D is performed, computer 100 marks one set of controllable parameter values for each set of measurements of observable parameters as a “current set” and another set of controllable parameter values for each set of measurements of observable parameters as a “backup” set. During normal operation, the current set is used, and the backup is used if the modem performance with the current set is found to be inadequate.

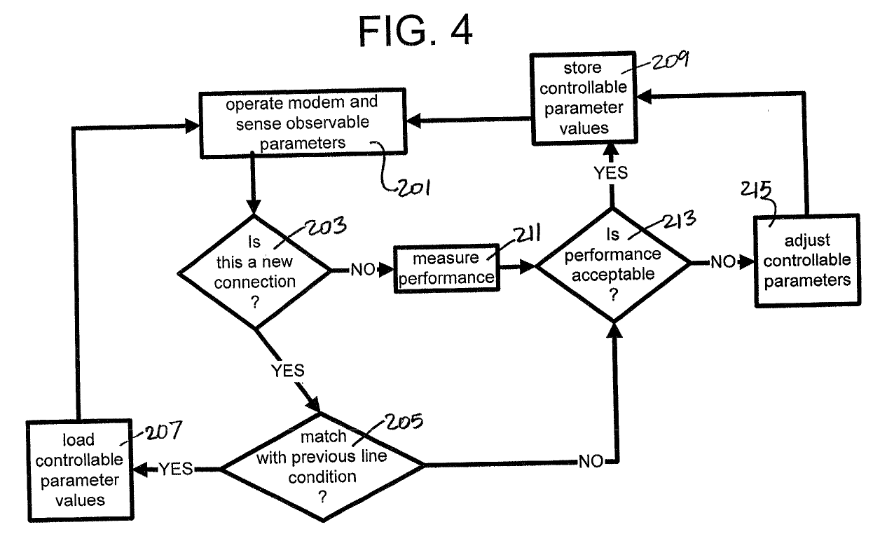

In one embodiment, in addition to the acts described above in reference to FIG. 2, computer 100 performs acts 211, 213 and 215 as illustrated in FIG. 4. Note that in this embodiment, one or more of acts 209A-209E described above in reference to FIG. 3 may or may not be performed, depending on the implementation. Prior to storage of the values of controllable parameters in act 209, computer 100 optionally measures performance in act 211 (FIG. 4) and thereafter checks in act 213 whether the performance is acceptable. The performance measurement in act 211 is an optional act and may not be required, for example, if performance is measured in terms of observable parameters that were sensed in act 201 (described above).

Alternatively, performance may be measured by sensing additional parameters if necessary, or by otherwise determining certain measurements (e.g. by use of formula), and in this aspect the performance measure is a higher-level concept whereas parameter sensing is a lower level concept. Examples of performance measure obtained in act 211 include stability of a connection (as measured, for example, by duration between re-connects), connection speed, and set up time. Performance measure is the effect of setting values to the controllable parameters, not the reason for setting values of the controllable parameters, thus, it is not measured in act 201.

Performance measure may be derived from the results of sensing low-level parameters that are not sensed in act 201. For example, the stability of a connection, as a performance measurement, may be represented as a weighted summation of the sensed values of a number of low-level parameters. One example of a performance measure is the sum of the durations between retrains divided by the total number of retrains. Another example of performance measure is the sum of durations between rate-renegotiations divided by the total number of rate-renegotiations. Yet another example of a performance measure is a weighted average of the just-described two performance measure examples (such numbers may be scaled so that they are each of the same order of magnitude before being combined, and the more important number (such as retrain) is weighted more heavily when being combined into a single performance measure).

When performance is determined to be acceptable, computer 100 goes to act 209 (described above in reference to FIG. 2), and otherwise goes to act 215 to adjust the values of controllable parameters. For example, a connection speed of 28.8 Kbps is acceptable when modem 190 is between 25,000 and 30,000 feet from the central office of a telephone service provider, but not acceptable when the distance is less than 15,000 feet.

To guide act 215 of adjusting, computer 100 may identify the difference between a measurement of an observable parameter and a corresponding reference for the observable parameter, and use the difference to determine an appropriate set of values of controllable parameters. For example, computer 100 may find that the receive power is too low, and in act 215 the computer 100 may adjust transmit power of modem 190 by an amount that is proportional to the difference between the receive power and a reference value. Therefore, if the receive power is low by a certain amount, the transmit power is proportionately increased.

In the specific embodiment illustrated in FIG. 4, computer 100 goes from act 215 directly to act 209 to store the values as soon as they are adjusted, although in an alternative embodiment, computer 100 may go from act 215 to act 201 (as described above, to operate modem 190 and to sense the observable parameters). In other embodiments, computer 100 may return from act 215 to act 211 (also described above).

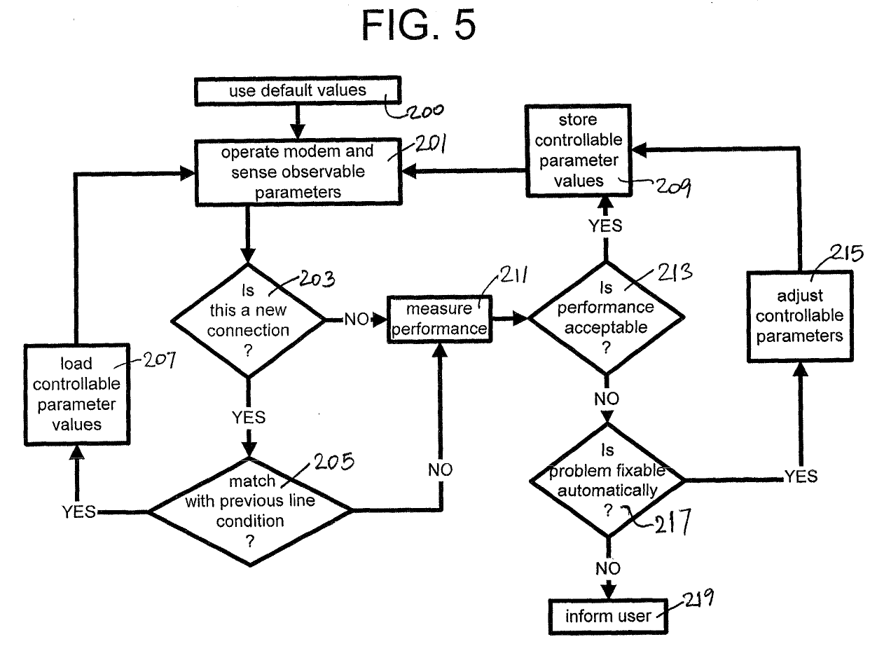

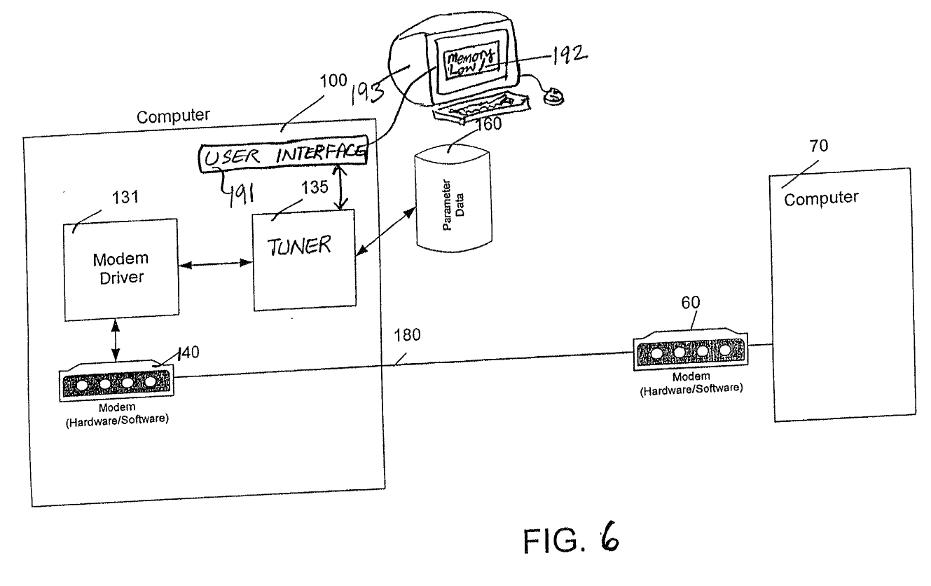

In one embodiment, in addition to the above-described acts in reference to FIG. 4, computer 100 performs acts 217 and 219 illustrated in FIG. 5. Specifically, in act 213 if the modem performance is not acceptable, computer 100 goes to act 217 and checks if the performance can be improved by adjusting one of the controllable parameters and/or changing one or more algorithms used in operation of modem 190. If the modem behavior cannot be changed to improve performance (e.g. even with retraining and reconnecting), the user is notified in act 219. The user may be informed with a status message, such as message 192 (e.g. “low memory” illustrated in FIG. 6) displayed by a user interface 191 on a display device 193. Such a message may include a suggestion for corrective action that may be taken by a user, e.g. rebooting the system, power cycling the modem, or shutting down other applications.

Therefore, tuner 135 changes the behavior of modem 190 (FIG. 5) while informing a user and/or obtaining user approval for the change. Changing modem behavior after approval by a user as described above causes a modem 190 to adapt its behavior to the environment with the user's cooperation and assistance. Depending on the embodiment, act 219 may be performed at other times as well, to inform the status to the user via a user interface 191 that pops up a message 192, and thereafter returns to act 209.

Message 192 may inform the user not only of the measurement that is causing a change in the modem behavior, but also may indicate the change in the modem behavior, e.g. that a low speed protocol is being used. Moreover, message 192 that is displayed by computer 100 may automatically notifying the user of an environment of the modem represented by one or more of the measurements, such as channel noise, and receiving power. Furthermore, message 192 may notify the user of a characteristic of the modem represented by one or more measurements, such as channel noise, receiving power.

Examples of measurement of observable parameters and changing of controllable parameters in the manner illustrated in one of FIGS. 2-5 are described next. Although certain examples are described, other such examples will be apparent to the skilled artisan in view of the disclosure.

As noted above, the computer measures (e.g. see act 201 in FIG. 5) a number of observable parameters, and in one embodiment one such parameter is the number Iₘ of missed interrupts in Sₘ seconds as described in U.S. patent application Ser. No. 09/967,758 entitled “Interrupt Counter” filed by Long Wang and incorporated by reference above. In this example, the computer checks if the number Iₘ is greater than a predetermined number Nₘ (e.g. in act 213). If so, the computer goes to act 217 (FIG. 5) to determine if this problem is fixable automatically. In this example, the problem is not automatically fixable, and therefore computer 100 informs the user in act 219 that operation of the modem is unstable because of low system resources.

In another example, computer 100 measures peak power of noise and average power of noise (e.g. see act 201 in FIG. 5). Thereafter, computer 100 checks if the peak power is greater than average power by Xₙ dB for Nₙ number of times that a sample is received in act 213. If so, the computer 100 determines in act 217 that the problem is not fixable automatically, and goes to act 219. In act 219 (FIG. 5), the computer informs the user that operation of the modem is unstable because of noisy channel.

In yet another example, the computer 100 senses a number being dialed (e.g. see act 201 in FIG. 4). Thereafter, in act 203 the computer 100 checks if the current connection is a new connection (meaning that values of controllable parameters haven't yet been loaded from memory), and if so goes to act 205 (FIG. 4). In act 205, the computer 100 checks if the number being dialed is same as a number previously saved in memory. If so, the computer 100 loads the controllable parameters (see act 207 in FIG. 4) from memory. In this embodiment, the controllable parameters include values indicating the need to disable V.8bis and Kflex protocols. Thereafter, the computer 100 returns to act 201, to continue to operate the modem, with either disabling or enabling V.8bis and Kflex as indicated in the values loaded from memory.

If the computer 100 finds that the number being dialed is different from a number previously saved in memory in act 205 (FIG. 4), then the computer senses (in act 201) a V.90 capability flag during performance of V.8 protocol sent from the remote modem. This flag indicates whether or not protocol V.90 is available. Next, the computer checks if V.90 connection is successfully formed (in act 213) and if so, goes to act 215 (FIG. 4) to update the corresponding controllable parameter in memory (for future use with this telephone number). Note that if the telephone number is not previously saved, then the computer 100 saves a new set of controllable parameter values (including the V.90 flag), the new telephone number, and an association between them, as illustrated by act 209 (FIG. 4).

In still another example, the computer 100 senses a number being dialed (e.g. see act 209 in FIG. 4) and line probing result (in phase 2). Thereafter, in act 203 the computer 100 checks if the current connection is a new connection (meaning that values of controllable parameters haven't yet been loaded from memory), and if so goes to act 205. In act 205, the computer 100 checks if the number being dialed is same as a number previously saved in memory and if the line probing result is within a range of Xₑ dB (e.g. within 1 dB) from a previously saved line probing result in memory. If so, the computer 100 loads the controllable parameters (see act 207) from memory. In this embodiment, the controllable parameters include equalizer coefficients. Thereafter, the computer returns to act 201, to continue to operate the modem, with the equalizer coefficients loaded from memory.

If the computer 100 finds that the number being dialed is different from a number previously saved in memory or if the line probing result differs by more than Xₑ dB, then the computer 100 determines the equalizer coefficients for this connection (in act 215). Thereafter, in this example, the computer 100 returns to act 211 by skipping act 209, and checks in act 213 if the performance is acceptable (e.g. checks if the equalizer has converged or if the connection has continued for a predetermined amount of time Me, such as 1 minute). If performance is acceptable, computer 100 goes to act 215 to update the corresponding controllable parameter in memory (e.g. the current equalizer coefficients are saved for future use with this telephone number).

Note that if the performance is not acceptable in act 213, then the computer goes to act 217 (FIG. 5) to determine if the problem is automatically fixable. In this example, the problem is fixable automatically, and therefore computer 100 goes to act 215. In act 215, the computer 100 adjusts the equalizer coefficients based on a difference between equalizer output and slicer output, using an adaptive method, such as least mean squared method well known in the art. Thereafter, the computer 100 returns to act 201 to continue to operate the modem with the new coefficients. For an example of use of such coefficients, see U.S. Patent Application, Attorney Docket No. M-12492 US.

In another example, the echo canceller coefficients are handled by computer 100 in the same manner as that described above for the equalizer coefficients.

In yet another example, the computer 100 senses power of the received signal (e.g. see act 201) averaged over any predetermined period during which transmission power from remote modem is constant (e.g. as defined in the V.90 specification). Thereafter, the computer goes to act 213 (whether or not the connection is new in act 203 and skipping act 211), and the computer 100 checks if the receive power is lower than Xr dBm (e.g. −35 dBm) by the amount Yr dB (e.g. 3 dB). If not, the computer 100 does not adjust transmission power. If the decision in act 213 is yes, the computer 100 goes to act 217 and determines that the problem is automatically fixable and goes to act 215 and increases the controllable parameter transmit power by Zr dB (e.g. 3 dB), and thereafter continues to operate the modem with the new transmit power (see act 201).

Numerous modifications and adaptations of the various embodiments, examples, implementations and illustrations described herein will be apparent to the skilled artisan in view of the disclosure. For example the method illustrated in FIG. 2 can be used with wireline modems in some embodiments, and with wireless modems in other embodiments. Moreover, instead of automatically selecting and setting just equalizer coefficients, in another embodiment, derivatives of equalizer coefficients are automatically selected and set as described in the related U.S. Patent Application No. 60/326,136 that has been incorporated by reference above. Furthermore, although a programmed computer executing software that performs certain acts has been described herein as being used in certain embodiments, in other embodiments such a programmed computer may be replaced by hardware (or a combination of hardware and software) that performs one or more such acts (e.g. the functions of a tuner may be performed in hardware). Moreover, although in certain embodiments acts of the type described herein are performed in a voice-band modem, such acts can also be performed in non-voice-band modems, such as a wireless modem.

Numerous such modifications and adaptations of the embodiments, examples, illustrations and implementations of the type described herein are encompassed by the attached claims.

1. A method of operating a modem, the method comprising:
automatically sensing a number of observable parameters;
automatically selecting and setting, based on measurements during sensing, one of a number of sets, each set comprising a value of at least one controllable parameter, the value being obtained from at least one previous connection of the modem.

2. The method of claim 1, the method further comprising:
measuring performance of the modem based on sensing; and
repeatedly adjusting the value of the at least one controllable parameter and repeating the act of measuring until a predetermined criteria of performance is met.

3. The method of claim 2, the method further comprising:
identifying a difference between a reference, and a performance measurement obtained during said measuring performance; and
using the difference to guide the act of “adjusting the value.”

4. The method of claim 1, the method further comprising:
automatically storing in memory a set of values of controllable parameters and said measurements made during the act of “automatically sensing” and an association between said set and said measurements.

5. The method of claim 4, wherein said measurements form a set in a plurality of sets of measurements currently stored in memory, the method further comprising:
automatically sensing said observable parameters again to obtain current measurements; and
if the current measurements are outside predetermined ranges of each set of measurements in the plurality of sets of measurements, automatically storing a new set of values of controllable parameters and said current measurements and an association therebetween.

6. The method of claim 4, wherein said measurements are hereinafter “previous measurements”, the method further comprising:
automatically sensing said observable parameters again to obtain current measurements; and
if the current measurements are within predetermined ranges of corresponding previous measurements, automatically using a set of values of controllable parameters previously saved in said memory.

7. The method of claim 6, the method further comprising:
if the current measurements are within the predetermined ranges of corresponding previous measurements and if a new value for a controllable parameter is within a predetermined range of a corresponding value of said controllable parameter in the set currently stored in memory, automatically updating in memory said corresponding value with said new value.

8. The method of claim 6, wherein a plurality of sets of values of controllable parameters are currently stored in memory and associated with the previous measurements, and said set is designated as a “current set”, the method further comprising:
if the current measurements are within the predetermined ranges of corresponding previous measurements and if a new value for a controllable parameter is within a predetermined range of a corresponding value of said controllable parameter in a second set in said plurality of sets that is different from the current set, automatically updating in memory said corresponding value with said new value in said second set, and designating said second set as the “current set.”

9. The method of claim 6, wherein a plurality of sets of values of controllable parameters are currently stored in memory and associated with the previous measurements, and said set is designated as a “current set”, the method further comprising:
if the current measurements are within the predetermined ranges of corresponding previous measurements and if a new value for a controllable parameter is outside a predetermined range of a corresponding value of said controllable parameter in all sets in the plurality of sets, automatically creating in memory an additional set including said new value, and designating said additional set as the “current set”.

10. The method of claim 1, the method further comprising:
automatically notifying the user of an environment of the modem represented by at least one of the measurements.

11. The method of claim 1, the method further comprising:
automatically notifying the user of a characteristic of the modem represented by at least one of the measurements.

12. The method of claim 1, the method further comprising:
automatically displaying an instruction to the user to improve performance of the modem.

13. The method of claim 1, wherein the controllable parameter is an equalizer coefficient.

14. A modem comprising:
means for automatically sensing a number of observable parameters; and
means for automatically selecting and setting, based on measurements during sensing, one of a number of sets of values of controllable parameters, the values being obtained from at least one previous connection of the modem.

15. The modem of claim 14 further comprising:
means for measuring performance of the modem based on sensing; and
means for repeatedly adjusting the values of controllable parameters and repeatedly measuring until a predetermined criteria of performance is met.

16. The modem of claim 15 further comprising:
means for identifying a difference between a reference, and a performance measurement obtained from said means for measuring performance; and
means for using the difference to supply a control signal to the means for repeatedly adjusting the values of controllable parameters.

17. The modem of claim 14 further comprising:
means for automatically storing in memory a set of values of controllable parameters and said measurements made by the means for automatically sensing and an association between said set and said measurements.

18. The modem of claim 14, wherein said measurements form a set in a plurality of sets of measurements currently stored in memory, the modem further comprising:
means for automatically storing a new set of values of controllable parameters and a set of current measurements and an association therebetween, if the current measurements are outside predetermined ranges of each set of measurements in memory.

19. The modem of claim 14, wherein said means for automatically sensing generates “previous measurements” in a previous connection, and also generates “current measurements” in a current connection, the modem further comprising:
means for automatically using a set of values of controllable parameters previously saved in said memory if the current measurements are within predetermined ranges of corresponding previous measurements.

20. The modem of claim 18 further comprising:
means for automatically updating in memory a value of a controllable parameter with a new value if the current measurements are within the predetermined ranges of corresponding previous measurements and if said new value is within a predetermined range of said value of said controllable parameter currently stored in memory.

21. The modem of claim 17, wherein a plurality of sets of values of controllable parameters are currently stored in memory and associated with the previous measurements, and said set is designated as a “current set”, the modem further comprising:
means for automatically creating in memory an additional set including a new value for a controllable parameter, and means for designating said additional set as the “current set” if the current measurements are within the predetermined ranges of corresponding previous measurements and if said new value is outside a predetermined range of a corresponding value of said controllable parameter in all sets in the plurality of sets

22. The modem of claim 14 further comprising:
means for automatically displaying an instruction to the user to improve performance of the modem.

23. The modem of claim 14 further comprising:
non-volatile memory encoded with the sets of values of controllable parameters.

24. The modem of claim 23 wherein:
the non-volatile memory is further encoded with a set of measurements associated with each set of values of controllable parameters.

25. The modem of claim 23 wherein:
the non-volatile memory is further encoded with predetermined ranges of sets of measurements associated with each set of values of controllable parameters.
